(19) United States
(12) Patent Application Publication
(10) Pub. No.: US 2009/0183949 A1
(43) Pub. Date: Jul. 23, 2009

(54) STEPLADDER

(76) Inventors: LEONS BARANOVSKIS, Airmont, NY (US); Mareks Zeltins, Stratford, CT (US)

Correspondence Address: James Ray & Associates, 2640 Pitcairn Road, Monroeville, PA, 15146, US

(21) Appl. No.: 12/356,739

(22) Filed: Jan. 21, 2009

Related U.S. Application Data
(60) Provisional application No. 61/022,446, filed on Jan. 21, 2008.

(51) Int. Cl. E06C 1/39

(52) U.S. Cl. 182/204

(57) ABSTRACT

A stepladder includes a first ladder having a first side rail and a second side rail and step members disposed there between. A second ladder includes a third side rail and a fourth side rail and step members disposed there between. Such ladders are pivotally connected for positioning between an open position and a closed position. A platform is at least one of pivotally attached to an upper end of at least one of such first side rail, such second side rail, such third side rail, and such fourth side rail, and permanently attached to an upper end of at least one of such first side rail, such second side rail, such third side rail, and such fourth side rail, and a combination thereof. A telescoping portion is disposed on each bottom end of such side rails, for selectively extending and retracting the length of each side rail.

### CROSS REFERENCE TO RELATED APPLICATION

This patent application is related to and claims priority from U.S. Provisional Patent Application Ser. No. 61/022,446 filed Jan. 21, 2008.

### FIELD OF THE INVENTION

The present invention relates, in general, to ladders and, more particularly, this invention relates to a stepladder for placement in uneven areas.

### BACKGROUND OF THE INVENTION

Prior to the conception and development of the present invention, ladders and stepladders, as are generally well known in the prior art, have been used to assist users in climbing to a desired height to reach otherwise unreachable objects, structures, portions of structures, and the like. Unfortunately, climbing up ladders can be dangerous, frightening, difficult, and uncomfortable, especially if the ladder has been placed on uneven ground.

### SUMMARY OF THE INVENTION

The present invention provides a stepladder. Such stepladder includes a first ladder member manufactured from a first predetermined material. Such first ladder member includes a first side rail and a second side rail and a first plurality of equally spaced apart step members disposed between such first side rail and such second side rail. A second ladder member is manufactured from a second predetermined material and includes a third side rail and a fourth side rail and a second plurality of equally spaced apart step members disposed between such third side rail and such fourth side rail. Such stepladder further includes means for pivotally connecting such first ladder member and such second ladder member such that such ladder members may be selectively positioned between an open position for climbing upon by a user and a closed position for storage. A platform member is manufactured from a third predetermined material and has a predetermined shape and a predetermined size. Such platform member is at least one of pivotally attached to an upper end of at least one of such first side rail, such second side rail, such third side rail, and such fourth side rail, and permanently attached to an upper end of at least one of such first side rail, such second side rail, such third side rail, and such fourth side rail, and a combination thereof. A telescoping portion is disposed on each bottom end of such first side rail, such second side rail, such third side rail, and such fourth side rail, for selectively extending and retracting the length of each one of such first side rail, such second side rail, such third side rail, and such fourth side rail.

### OBJECTS OF THE INVENTION

It is, therefore, one of the primary objects of the present invention to provide a stepladder which includes adjustable legs such that such stepladder may be positioned on an uneven ground surface in a stable manner.

Another object of the present invention is to provide a collapsible stepladder which includes step members on both sides thereby extending the area a user may reach when standing on such step ladder and requiring less repositioning of such stepladder.

Still another object of the present invention is to provide a stepladder having a top platform including at least one of a plurality of apertures, a plurality of hooks, and a combination thereof for supporting predetermined tools at least one of therein, thereon, and a combination thereof.

Yet another object of the present invention is to provide a stepladder which includes four legs, each leg including a telescoping portion for adjusting each leg in height such that such legs may each be adjusted according to the levelness of the ground upon which such legs sit.

An additional object of the present invention is to provide a stepladder which will be more stable than traditional ladders.

In addition to the various objects and advantages of the present invention described with some degree of specificity above it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is a partial perspective view of the invention according to one embodiment of the invention.

FIG. 2 is a partial perspective view of the invention according to one embodiment of the invention in which a user is standing on the invention after having adjusted the telescoping portions according to the uneven ground supporting such invention.

FIG. 3 is a partial perspective view of the invention according to one embodiment of the invention.

### BRIEF DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

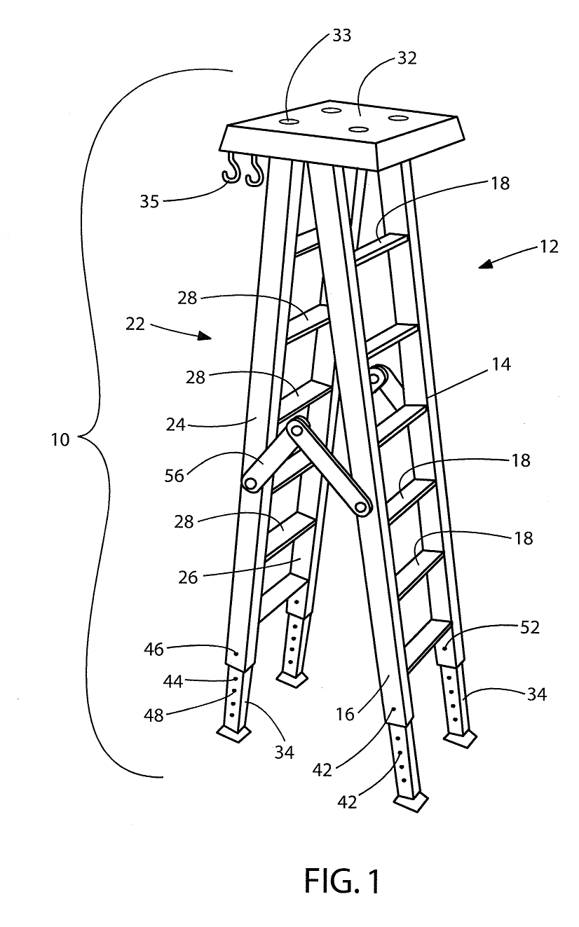

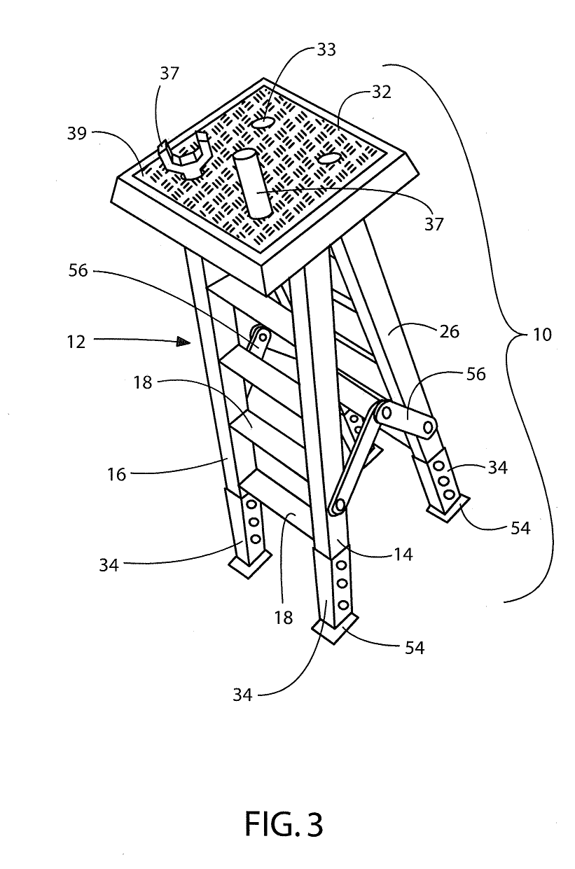

Reference is now made, more particularly, to FIGS. 1-3.

A stepladder, generally designated 10, is provided. Such stepladder 10 includes a first ladder member, generally designated 12, manufactured from a first predetermined material. Such first ladder member 12 includes a first side rail 14 and a second side rail 16 and a first plurality of equally spaced apart step members 18 disposed between such first side rail 14 and such second side rail 16. It is presently preferred that such first predetermined material is at least one of metal, plastic, and a combination thereof.

A second ladder member, generally designated 22, is manufactured from a second predetermined material and includes a third side rail 24 and a fourth side rail 26 and a second plurality of equally spaced apart step members 28 disposed between such third side rail 24 and such fourth side rail 26. It is presently preferred that such second predetermined material is at least one of metal, plastic, and a combination thereof.

Such stepladder 10 further includes means (not shown) for pivotally connecting such first ladder member 12 and such second ladder member 22 such that such ladder members may be selectively positioned between an open position for climbing upon by a user 11 and a closed position for storage.

A platform member 32 is manufactured from a third predetermined material and has a predetermined shape and a predetermined size. Such platform member 32 is at least one of pivotally attached to an upper end of at least one of such first side rail 14, such second side rail 16, such third side rail 24, and such fourth side rail 26, and permanently attached to an upper end of at least one of such first side rail 14, such second side rail 16, such third side rail 24, and such fourth side rail 26, and a combination thereof. It is presently preferred that such third predetermined material is at least one of metal, plastic, wood, and a combination thereof. It is presently preferred that such predetermined shape is substantially rectangular. It is further presently preferred that such predetermined size is between about 10 inches and about 14 inches wide and between about 16 inches and about 20 inches long. According to a preferred embodiment, such platform member 32 further includes at least one of at least one aperture 33 disposed there through, at least one hook member 35 attached thereto at a predetermined location thereon, and a combination thereof, for supporting predetermined tools 37 at least one of therein, thereon, and a combination thereof. It is further presently preferred that such platform member 32 includes a non-slip surface 39 disposed thereon, such non-slip surface 39 is preferred to be at least one of an abrasive, an elastomeric member, such as rubber, and a combination thereof.

A telescoping portion 34 is disposed on each bottom end of such first side rail 14, such second side rail 16, such third side rail 24, and such fourth side rail 26, for selectively extending and retracting the length of each one of such first side rail 14, such second side rail 16, such third side rail 24, and such fourth side rail 26. It is presently preferred that at least one of such telescoping portions 34 and each one of such first side rail 14, such second side rail 16, such third side rail 24, and such fourth side rail 26 includes a hollow portion (not shown) such that at least one of such telescoping portions 34 slidably fit within such rail members and such rail members slidably fit within such telescoping portions 34.

It is presently preferred that such stepladder 10 further includes a locking means 42 operably connected to each of such first side rail 14, such second side rail 16, such third side rail 24, such fourth side rail 26 and such telescoping portions 34 for selectively locking each of such telescoping portions 34 in place. According to a preferred embodiment, such locking means 42 includes a first portion 44 disposed on at least one of such telescoping portions 34 and each one of such first side rail 14, such second side rail 16, such third side rail 24, and such fourth side rail 26, and wherein such locking means 42 includes a second portion 46 disposed on at least one of such telescoping portions 34 and each one of such first side rail 14, such second side rail 16, such third side rail 24, and such fourth side rail 26, such first portion 44 and such second portion 46 being releasably engageable with each other. It is presently preferred that such first portion 44 is a plurality of spring loaded pin members 48 and such second portion 46 is a plurality of apertures 52.

It is presently preferred that each of such telescoping portions 34 further include a non-slip foot member 54 disposed closely adjacent a bottom portion thereof. Such non-slip foot members 54 are preferably manufactured from at least one of an abrasive, an elastomeric member, and a combination thereof. It is presently preferred that such elastomeric member is rubber.

It is presently preferred that such stepladder 10 further includes a bracing means 56. The bracing means 56 is meant to secure the ladder members together and to prevent such ladder members from moving apart more than a predetermined distance.

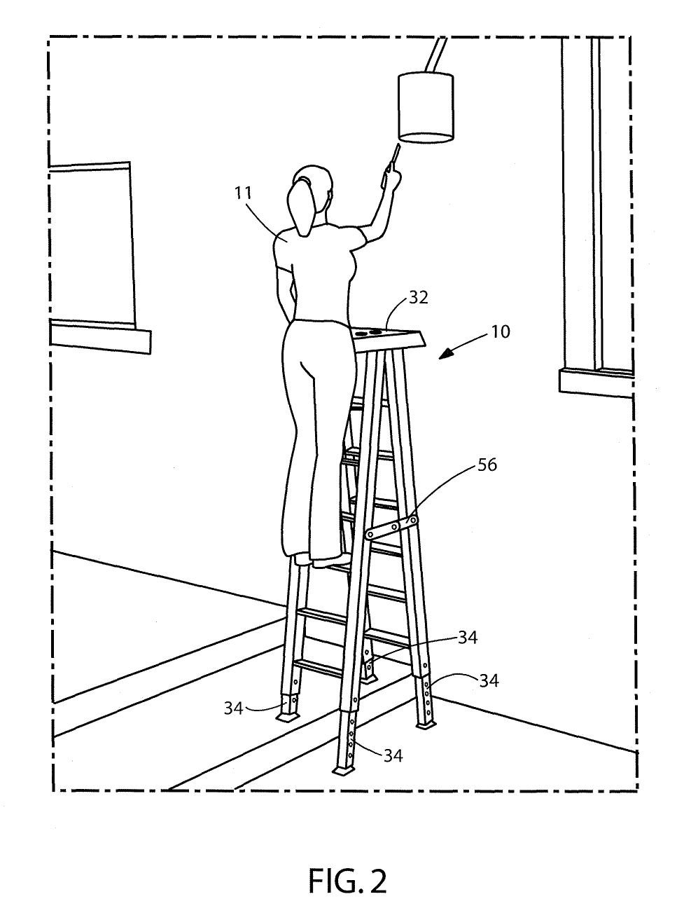

It is meant that the invention provide a safe to use stable stepladder. The stepladder is designed to enable a user 11 to adjust the telescoping portions according to the unevenness of the ground which supports such stepladder 10. For example, as illustrated in FIG. 2, the stepladder 10, has been implemented such that two of the four rail members have been extended to a length greater than that of the remaining two rail members thereby providing a stable device for climbing upon by such user 11 and preventing the user from being forced to climb a ladder which is tilted sideways and in danger of falling in order to reach a desired height.

While a presently preferred and various alternative embodiments of the present invention have been described in sufficient detail above to enable a person skilled in the relevant art to make and use the same it should be obvious that various other adaptations and modifications can be envisioned by those persons skilled in such art without departing from either the spirit of the invention or the scope of the appended claims.

We claim:

1. A stepladder comprising:
a. a first ladder member manufactured from a first predetermined material including a first side rail and a second side rail and a first plurality of equally spaced apart step members disposed between said first side rail and said second side rail;
b. a second ladder member manufactured from a second predetermined material including a third side rail and a fourth side rail and a second plurality of equally spaced apart step members disposed between said third side rail and said fourth side rail;
c. means for pivotally connecting said first ladder member and said second ladder member such that said ladder members may be selectively positioned between an open position for climbing upon by a user and a closed position for storage;
d. a platform member manufactured from a third predetermined material and having a predetermined shape and a predetermined size at least one of pivotally attached to an upper end of at least one of said first side rail, said second side rail, said third side rail, and said fourth side rail, and permanently attached to an upper end of at least one of said first side rail, said second side rail, said third side rail, and said fourth side rail, and a combination thereof; and
e. a telescoping portion disposed on each bottom end of said first side rail, said second side rail, said third side rail, and said fourth side rail, thereof for selectively extending and retracting the length of each one of said first side rail, said second side rail, said third side rail, and said fourth side rail.

2. A stepladder according to claim 1 wherein at least one of said telescoping portions and each one of said first side rail, said second side rail, said third side rail, and said fourth side rail, includes a hollow portion such that at least one of said telescoping portions slidably fit within said rail members and said rail members slidably fit within said telescoping portions.

3. A stepladder according to claim 2 wherein said stepladder further includes a locking means operably connected to each of said first side rail, said second side rail, said third side rail, said fourth side rail and said telescoping portions for selectively locking each of said telescoping portions in place.

4. A stepladder according to claim 3 wherein said locking means includes a first portion disposed on at least one of said telescoping portions and each one of said first side rail, said second side rail, said third side rail, and said fourth side rail, and wherein said locking means includes a second portion disposed on at least one of said telescoping portions and each one of said first side rail, said second side rail, said third side rail, and said fourth side rail, said first portion and said second portion being releasably engageable with each other.

5. A stepladder according to claim 4 wherein said first portion is a plurality of spring loaded pin members and said second portion is a plurality of apertures.

6. A stepladder according to claim 1 wherein said first predetermined material is at least one of metal, plastic, and a combination thereof.

7. A stepladder according to claim 1 wherein said second predetermined material is at least one of metal, plastic, and a combination thereof.

8. A stepladder according to claim 1 wherein said third predetermined material is at least one of metal, plastic, wood, and a combination thereof.

9. A stepladder according to claim 1 wherein said platform member further includes at least one of, at least one aperture disposed there through, at least one hook member attached thereto at a predetermined location thereon, and a combination thereof, for supporting predetermined tools at least one of therein, thereon, and a combination thereof.

10. A stepladder according to claim 1 wherein said predetermined shape is substantially rectangular.

11. A stepladder according to claim 1 wherein said predetermined size is between about 10 inches and about 14 inches wide and between about 16 inches and about 20 inches long.

12. A stepladder according to claim 1 wherein said platform member further includes a non-slip surface disposed thereon.

13. A stepladder according to claim 12 wherein said non-slip surface is at least one of an abrasive, an elastomeric member, and a combination thereof.

14. A stepladder according to claim 1 wherein said stepladder further includes a bracing means.

15. A stepladder according to claim 1 wherein each of said telescoping portions further include a non-slip foot member disposed closely adjacent a bottom portion thereof.

16. A stepladder according to claim 15 wherein said non-slip foot members are manufactured from at least one of an abrasive, an elastomeric member, and a combination thereof.

17. A stepladder according to claim 16 wherein said elastomeric member is rubber.
